(19) United States
(12) Patent Application Publication
(10) Pub. No.: US 2003/0039337 A1
(43) Pub. Date: Feb. 27, 2003

(54) Non-real-time conference calls using a telephony user interface

(76) Inventors: Kenneth Davies, Ossining, NY (US); Paul S. Cohen, Yorktown Heights, NY (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/682,293

(22) Filed: Aug. 16, 2001

(51) Int. Cl. H04M 1/64; H04M 11/00

(52) U.S. Cl. 379/88.01; 379/88.18; 379/202.01

(57) ABSTRACT

A method and system for participating in and controlling a non-real-time voice conference. By recording a first participant's voice for playback to a second participant that is not connected at the same time as the first participant, a new type of voice conference is created.

### CROSS REFERENCE TO RELATED APPLICATIONS

This application is related to co-pending application Ser. No. 09/908,653, filed Jul. 20, 2001 entitled “Active Voice Messaging” naming Danny Schwartz as sole inventor. The contents of that application are incorporated herein by reference.

### BACKGROUND OF INVENTION

1. Field of the Invention

The present invention is directed to a telephony user interface for participating in an interactive information exchange forum between multiple users, and in one embodiment to a method and system for participating in at least one of a chat session and a chatroom using a telephony interface.

2. Discussion of the Background

Chat sessions and chatrooms using a computer interface have become very popular. Instant messaging from AOL and other related technologies allow users to exchange text messages using the mouse and keyboard.

Known conference call systems allow multiple conferees to exchange voice information in real-time using a voice bridge. As a result, if a first conferee is not connected to the call when a second conferee speaks, the speech conveyed by the second conferee is not conveyed to the first conferee.

### SUMMARY OF INVENTION

It is an object of the present invention to provide an interactive information exchange forum between multiple users, even when one of the users is not connected at the same time as the others. In one such embodiment, the exchange of information utilizes at least one telephony device.

### BRIEF DESCRIPTION OF DRAWINGS

FIG. 1 is a block diagram of a telephone device engaging in an information exchange with a conference system; and

FIG. 2 is a schematic illustration of a computer for implementing a conference controller according to the present invention.

### DETAILED DESCRIPTION

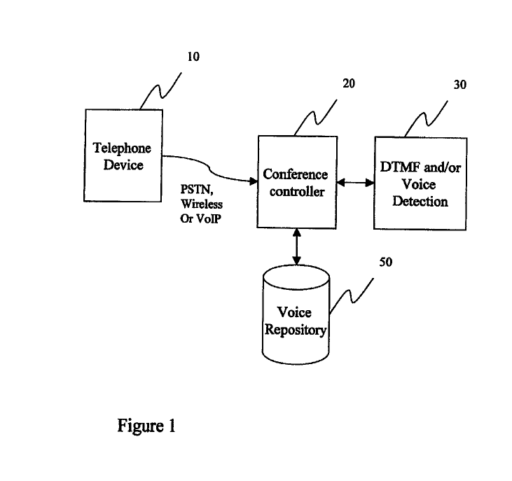

Referring now to the drawings, wherein like reference numerals designate identical or corresponding parts throughout the several views, FIG. 1 is a block diagram of a system for performing interactive information exchanges, and preferably non-realtime voice conference. As used herein, a “non-realtime voice conference” is a voice conference with at least one conference participant (i.e., conferee) that is not connected at the same time as the other conferees. For example, at least one conferee is non-realtime and at least one conferee is realtime. On the other hand, plural conferees can all be non-realtime with the option to connect to form a real-time conference if at least two conferees eventually connect simultaneously. The system includes a telephone device 10 and a conference controller 20 (including or connected to a DTMF and/or Voice detection/recognition system 40 and a voice repository 50).

The telephone device 10 can be any wired or wireless telephony device. Such wired devices include, but are not limited to, POTS telephones, DSL, ISDN, and Voice over IP devices (including computers utilizing Net2Phone software) over any communications media. Wireless devices include, but are not limited to, cellular, PCS, and cordless devices.

The DTMF and/or voice detection/recognition system 40 includes automatic speech recognition (ASR), text-to-speech (TTS), and DTMF capabilities that provide control signals to the conference controller 20.

The voice repository SO enables voice to be recorded from and played back to telephony devices 10 as will be discussed in greater detail below with respect to the examples. The voice repository 50 need not be located at the same location that actually records a participant' voice. Instead, the voice may be transferred after recording using any transfer protocol, either analog or digital. For example, the recorded voice can be transferred to the voice repository 50 using an IP network and FTP, HTTP, etc.

A telephone device 10 contacts a conference controller 20 in any number of known ways (e.g., by dialing a conference bridge and entering a conference number, by dialing a conference operator and asking for a specific conference, or by establishing a VoIP connection to the conference controller 20). Once the telephone device has established a connection to the appropriate conference, the user may interact with the conference controller 20 using voice and/or DTMF tones.

In the example below, “Michael_Pastor”, “VGoffin22”, and “PSCohen” are user-IDs employed by computer systems for e-mail, instant messaging, etc. If those user-IDs are previously unknown to the conference controller 20, they are added by a separate interactive or batch capability.

### EXAMPLE 1

Ken connects to the conference controller 20, and the dialog below occurs with Ken speaking the phrases in quotes and the conference controller responding as shown.

| Ken | Conference Controller 20 |
|---|---|
| | What can I do for you? [pre-recorded |
| | speech] |
| “Net2Phone Chat” | |
| | You have 2 open chats: Michael_{—} |
| | Pastor and VGoffin22 [pre-recorded |
| | speech & TTS] |
| “Michael Pastor” | |
| | 2 appends since you last joined. |
| | Listen to ALL or specify when. [pre- |
| | recorded speech] |
| “Since last joined” | |
| | “I was thinking that we need to make |
| | it more attractive for them to work |
| | with us . . . |
| | [recording of Participant #1] |
| | “Yes but we have to be sure we're |
| | not giving away the . . . [recording of |
| | Participant #2] |
| | “I know. I was thinking about bring- |
| | ing them in on our AT&T deal” |
| | [recording of Participant #1] |
| | “O.K. let's do that. See you at 5:00” |
| | [recording of Participant #2] |
| | Join chat? [pre-recorded speech] |
| “Yes” | |
| | Joined - no-one on at present. [pre- |
| | recorded speech] |
| “Ken here - see you at 5:00 also.” | |
| *** [Ken using DTMF] | |
| | You have 2 open chats: Michael_{—} |
| | Pastor and VGoffin22 [pre-recorded |
| | speech & TTS] |
| “VGoffin22” | |
| | No appends since you last joined |
| | [pre-recorded speech] |
| *** [Ken using DTMF] | |
| | You have 2 open chats: Michael_{—} |
| | Pastor and VGoffin22 [pre-recorded |
| | speech & TTS |
| “New chat” | |
| | Please identify the participants. [pre- |
| | recorded speech] |
| “P S Cohen” | |
| | PSCohen [TTS] |
| “End” | |
| | Begin chat [pre-recorded speech] |
| “Paul, what time are you going | |
| home tonight?” | |
| *** [Ken using DTMF] | |
| | You have 3 open chats: . . . [pre- |
| | recorded speech] |
| (Hang-up) | |

As shown above, telephone users can participate in a “conference call” whenever it is convenient for them to do so, even when some of the other participants are unavailable. Telephone end-users can have all the significant functionality of chat sessions and chat rooms that previously required them to have direct access to a computer. Participation is possible even where computer use is prohibited (e.g., certain portions of airplane trips). Actual voices of the participants can be heard, thereby eliminating misunderstandings, etc. that can occur when only written language is available. Other audio material (e.g., music) can be available to participants. Like with chat sessions, users authenticate themselves to the conference controller, thus restrictions can be placed on who can add to or listen to conferences. (Conferees can also be classified as “listen-only” or “listen and update” by the conference originator.) Using the conferee's identification, their contributions (and the times thereof) can be recorded by the conference controller. This allows skipping of conference segments by participant or time upon user request (e.g., via voice or DTMF). Similarly, a conferee can request to begin where he/she last left off without having to know the time of the last segment heard. In fact, users can agree to continue the session at a certain time and all participants can pick up what they missed before recommencing.

Appending to an existing conference can be performed either physically or logically. In the physical implementation the existing conference file is opened in append mode, and the new data is written at the end of the conference file. In the logical implementation, one or more conference segments are written to separate files and a table is kept identifying where each segment can be found in its corresponding file. For example, each segment for each new user may be implemented as a separate file so a conference with two users, each having spoken three times would create six separate files and a table (in a database or another file) with six entries for the file names and corresponding dates and participants. To add the next segment, a new file and a new table entry are created.

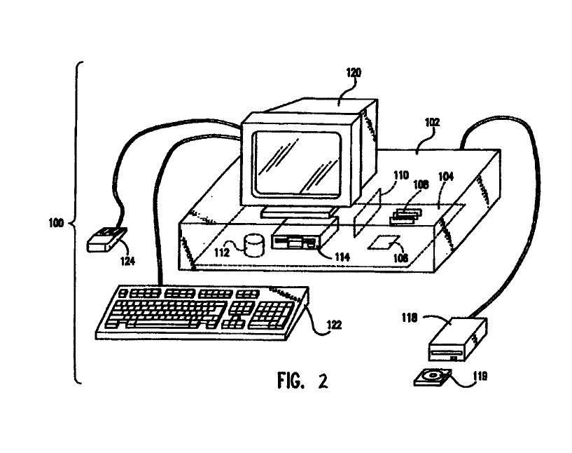

FIG. 2 is a schematic illustration of a computer system for implementing, according to one embodiment, the conference controller of FIG. 1. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or an Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings conferences and recorded voice messages.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for implementing a conference controller. The computer code devices of the present invention can be any interpreted or executable code mechanism, including but not limited to scripts, interpreters, dynamic link libraries, Java classes, and complete executable programs. The computer code devices of the present invention may be received dynamically across a network and executed on the receiving computer.

In light of the non-real-time nature of the conferences, it is not possible to terminate the conference when the last user disconnects. Instead, since users may come back to the conference later, the conference system must be told when to retire (or discard the contents of) a conference. Alternately, the conference controller can automatically retire a conference after a fixed period of time. Retired conferences can be stored to off-line storage (e.g., CD jukebox) before being removed from on-line storage (e.g., hard drives).

Numerous modifications can be made to the above disclosure without departing from the spirit of the invention. For example, conferees can be called automatically when a conference is to start so that they do not incur long distance charges. Moreover, conferees can call into a local phone number that transfers the conferee's voice to the conference controller via voice over IP to avoid long distance charges. Accordingly, the specification is not to be considered limiting and the scope of protection is defined by the claims hereafter.

1] a computer implemented method of controlling a non-real-time voice conference, comprising:
receiving first voice information from a first participant;
recording the first voice information in a voice repository;
playing the first voice information to a second participant that is not connected at the same time as the first participant.

2] The method as claimed in claim 1, further comprising specifying a list of conference participants using voice recognition.

3] The method as claimed in claim 1, further comprising:
receiving second voice information from the second participant;
appending the second voice information to the first voice information in the repository; and
playing the second voice information to at least one of the first participant and a third participant who is not connected at the same time as the second participant.

4] The method as claimed in claim 3, further comprising specifying whether to play only an unheard portion of the first and second voice information to a participant.

5] The method as claimed in claim 1, further comprising selecting a new non-real-time voice conference to participate in.

6] The method as claimed in claim 1, further comprising selecting, using voice recognition, a new non-real-time voice conference to participate in.

7] The method as claimed in claim 1, further comprising controlling the non-real-time voice conference using DTMF tones.

8] The method as claimed in claim 1, wherein the step of playing comprises delivering the first voice information to the second participant using packet switching of digitized voice.

9] The method as claimed in claim 1, wherein the step of playing comprises delivering the first voice information to the second participant using the public switched telephone network.

10] The method as claimed in claim 1, wherein the step of playing comprises delivering the first voice information to the second participant using the public switched telephone network and packet switching of digitized voice.

11] A computer readable medium containing computer code devices for controlling a computer to implement a non-realtime voice conference by performing the steps of:
receiving first voice information from a first participant;
recording the first voice information in a voice repository;
playing the first voice information to a second participant that is not connected at the same time as the first participant.

12] The computer readable medium as claimed in claim 11, further comprising controlling a computer to perform the step of specifying a list of conference participants using voice recognition.

13] The computer readable medium as claimed in claim 11, further comprising controlling a computer to perform the steps of:
receiving second voice information from the second participant;
appending the second voice information to the first voice information in the repository; and
playing the second voice information to at least one of the first participant and a third participant who is not connected at the same time as the second participant.

14] The computer readable medium as claimed in claim 13, further comprising controlling a computer to perform the step of specifying whether to play only an unheard portion of the first and second voice information to a participant.

15] The computer readable medium as claimed in claim 11, further comprising controlling a computer to perform the step of selecting a new non-real-time voice conference to participate in.

16] The computer readable medium as claimed in claim 11, further comprising controlling a computer to perform the step of selecting, using voice recognition, a new non-real-time voice conference to participate in.

17] The computer readable medium as claimed in claim 11, further comprising controlling a computer to perform the step of controlling the non-real-time voice conference using DTMF tones.

18] The computer readable medium as claimed in claim 11, wherein the step of playing comprises delivering the first voice information to the second participant using packet switching of digitized voice.

19] The computer readable medium as claimed in claim 11, wherein the step of playing comprises delivering the first voice information to the second participant using the public switched telephone network.

20] The computer readable medium as claimed in claim 11, wherein the step of playing comprises delivering the first voice information to the second participant using the public switched telephone network and packet switching of digitized voice.
